(19) United States
(12) Patent Application Publication
(10) Pub. No.: US 2011/0138206 A1
(43) Pub. Date: Jun. 9, 2011

(54) Power Management Method and Apparatus

(75) Inventor: Charles Garcia-Tobin, Cambs (GB)

(73) Assignee: NOKIA CORPORATION, Espoo (FI)

(21) Appl. No.: 12/678,072

(22) PCT Filed: Sep. 9, 2008
(86) PCT No.: PCT/GB2008/003059

§ 371 Date: Jan. 24, 2011

(30) Foreign Application Priority Data
Sep. 12, 2007 (GB) 0717786.8

(51) Int. Cl. G06F 1/32

(52) U.S. Cl. 713/322; 713/320

(57) ABSTRACT

Embodiments of the invention provide a power management subsystem which provides an interface which allows baseport subsystems such as device drivers and the like to register operational constraints on system resources such as power supplies, clocks, and the like, as well as to specify a maximum allowable wake-up time to ensure correct operation. Once registered, such operational constraints are then typically sorted to determine the strictest constraints, and the strictest constraints are then mapped to the characteristics of the various low-power modes offered by a particular device platform, to determine the most appropriate low power mode which can be entered whilst still allowing the registered constraints to be met. In this way, when required a device having the power management subsystem can still make use of low power modes when appropriate, without compromising the operation of base port sub systems such as device drivers, controllers, or the like. Additionally, the power management subsystem insulated the base port subsystems from the low power modes provided by the device, such that existing base port subsystem components can be used with the device, without requiring any bespoke tailoring thereto.

### TECHNICAL FIELD

The present invention relates to a power management method and apparatus, and in particular to a power management method and apparatus wherein multiple low power modes are available in a particular device.

### BACKGROUND TO THE INVENTION

It is known for devices, and in particular mobile devices such as mobile telephones, or the like, as well as other devices such as computers, media players, PDAs, or the like to support one or more low power modes. The operating systems of the devices will typically attempt entering the device into a low power mode when there is no activity. Typically, an OS provides an idle call back hook that is called when there is no process or thread to schedule. This hook can then be used by the base port or hardware abstraction layer to enter the device into a low power mode.

Devices generally support one or more low power modes. In these modes the CPU stops processing instructions until a wake up event, typically in the form of an interrupt, reinitiates processing. For each low power mode there is usually a significant wake up period between the assertion of the interrupt condition and the resumption of instruction execution by the CPU. When multiple low power modes are supported, this delay is usually proportional to the level of power saving offered by a mode. The more power saved, the longer the wake up period. Low power modes typically result in gating clocks and power supplies i.e. stopping the clocks and power supplies running. When multiple low power modes are supported, the amount of clocks or power supplies which are gated also increases with the level of power saving offered by a given mode.

FIG. 1 illustrates an example device 10, which may be, for example, a mobile telephone, smart phone, PDA, media player, computer, or some other similar device. Purely by way of example, device 10 in this case comprises a CPU 110, with associated RAM 108. A RAM controller 118, being a base port subsystem i.e. part of the operating system which directly controls the hardware of the device, is provided to control RAM 108. The CPU, RAM controller, and RAM form a core domain, powered by a core power domain 124, being a power supply to the core.

Additionally provided in the example device 10 is an LCD screen 106, a keyboard 104, and a universal asynchronous receiver/transmitter (UART) to translate data between a parallel and serial interface. Associated with these hardware elements are respective base port subsystems, representing a hardware abstraction layer for the operating system of the device. In particular, LCD screen 106 is provided with LCD controller 116, to control the LCD screen 106. Similarly, keyboard controller 114 is provided to control keyboard 104, and UART controller 112 is provided to control UART 10. LCD controller 116, keyboard controller 114, and UART controller 112, represent base port subsystems, i.e. that part of the operating system which represents the hardware of the device, to allow the operating system to interface with the hardware.

The LCD, UART, and keyboard together with their respective controllers all form part of the peripheral domain of the device, and are supplied with power from a peripheral power domain power supply PER_PD 122. This is a separate power domain from the core power domain CORE_PD 124, which powers the CPU and RAM in the core.

In addition to power supplies being provided to control the various device elements, the device elements are also dependent upon being supplied with appropriate clock signals. FIG. 1 illustrates the clocks which are provided to the various controllers, and in particular how the clocks are dependent upon each other. The dependency of the clocks will be more apparent with respect to the “clock tree” diagram of FIG. 2.

Considering FIGS. 1 and 2 together, the device 10 is provided with a master PLL 130, which provides a master clock signal from which all other clocks are derived. A RAM clock 140 is provided which derives a RAM_CLK signal from the clock signal from the master PLL 130, and supplies the RAM_CLK signal to the RAM controller 118. Similarly, a CPU clock 142 produces a signal CPU_CLK, which is provided to CPU 110.

With respect to the peripherals, a peripheral clock 132 is derived directly from the master PLL clock, to provide peripheral clock signal PER_CLK. This is then used by respective clocks for each of the peripherals to derive individual respective clock signals. Thus, for example, LCD controller 116 is fed with a clock signal LCD_CLK, produced by LCD clock 134, in dependence upon PER_CLK. Similarly, keyboard controller 114 is provided with a clock signal KB_CLK, from keyboard clock 138. KB_CLK is derived from PER_CLK. Likewise, UART controller 112 is provided with a clock signal UART_CLK, produced by UART clock 136, in dependence upon PER_CLK. Thus, it will be understood that in a typical device of the prior art, various clocks are used by various device elements, but that the clocks are typically dependent upon each other in a hierarchical arrangement, as described.

As mentioned, the device 10 may typically be provided with one or more low power modes, which the operating system of the device may cause the device to enter when there is no process or thread to be scheduled. FIG. 3 illustrates a table giving details of example low power or power save modes which may be entered, and the effect on the clocks, power domains, and wake up time of the device that each power save mode provides. For example, in row 302 a power save mode “WAIT”, being the least aggressive power save mode, and typically the default mode for the device, means that no clocks are turned off, and neither are any power domains. The wake up time for the device is very short, in this example 1 nanosecond.

The next most aggressive power save mode is “DOZE”, shown in row 304. Here, in this example the KB_CLK signal i.e. the keyboard clock is turned off, but no power domains are turned off. The wake up time for the CPU is approximately 300 nanoseconds.

The next most aggressive power save mode, “LIGHT SLEEP” has the properties shown in row 306. Here, the PER_CLK clock signal is turned off, but no power domains are turned off, and the wake up time is approximately 2000 nanoseconds. The effect of turning the PER_CLK signal off means that, recalling the hierarchical arrangement of FIG. 2, all of the peripheral clocks LCD_CLK, KB_CLK and UART_CLK are also disabled. Thus, if the respective peripheral controllers require their respective clocks for operating, then in the “LIGHT SLEEP” example power save mode this would not be possible.

The penultimate power save mode is “DEEP SLEEP” in this example, shown in row 308. Here, the PER_CLK clock signal is turned off, with the same ramifications as discussed above, as well as the RAM_CLK signal, provided to the RAM controller. Additionally, the power domain PER_PD which supplies power to the peripheral controllers is also turned off. As a consequence, the wake up time of the device is much longer, in this example 500,000 nanoseconds.

Finally, the most aggressive power save mode in this example is “COMA”, the properties of which are shown in row 310. Here, the master PLL 130 is turned off, which means that all clocks in the example device are disabled. Additionally, the power domain PER_PD is turned off. Accordingly, the wake up time is relatively long, in this case 2 million nanoseconds. Please note that the above power save mode properties are merely examples for the purposes of the present description. In embodiments of the invention different numbers of power save modes may be provided, each of which have different properties.

Generally, however, whilst the use of power save modes provides advantages in that power can be saved, an important requirement for battery powered devices, the mechanisms by which power is saved i.e. by gating clocks or power supplies, and providing lengthy wake up times, can have a negative effect on hardware device controllers, or other base port subsystems. In particular, two problems need to be avoided:—

1. If a base port subsystem is actively using a clock or power supply, then the idle call back should not enter a low power mode that will gate this clock or supply.
2. Additionally, if a subsystem cannot tolerate a lengthy wake up time, then the idle call back should limit itself to modes with wake up times smaller than the limits imposed by the subsystem.

For example, take the case of the UART controller 112. In a UART it is typical that the ability to detect the data line changing i.e. to detect incoming data still works even when the clocks are off. Typically a falling edge on this line can trigger an interrupt which in turn can wake up a sleeping CPU. The clocks for the UART do need then to be on, in order to be able to sample the data line to read a character. Therefore, when the CPU goes into a low power state, it can be awakened by the beginning of a data transmission arriving at the UART as this toggles the data line. However, if the UART clocks are not re-enabled quick enough, then even though the CPU has woken up, it might not be possible to read the character that was sent to the UART. Therefore, a UART controller 112 may require that its clock signal UART_CLK is provided all the time that the controller expects it may receive data. Additionally, the UART controller may have maximum requirements for CPU wake up time from the data line being toggled and the CPU being fully active, depending upon the speed of the data transmission received at the UART.

With such requirements on clock availability and wake up time, when an operating system including device controller elements such as UART controller 112, LCD controller 116, keyboard controller 114 etc. etc. are ported to a new device 10 which provides low power modes, conventionally either the effects of the low power modes on the device controllers has been ignored, or, in some cases, the device controllers have been specifically adapted to the particular device to which they are being ported, so as to be aware of the low power modes offered by the device. Obviously, this situation is not ideal, as it requires much additional design work on the part of the device controller designers and writers in order to allow the controllers to understand what low power modes are offered by the device platform 10. This increases product development time and cost. It would therefore be advantageous if such bespoke adaptation of the device drivers to a particular device 10 was not required, which would then allow an operating system to be ported to any new device 10 without involving such bespoke adaptation steps. Ideally, the peripheral device controllers such as UART controller 112, LCD controller 116, and keyboard controller 114, for example, should not need to have any knowledge of the low power modes offered by the device platform 10, and yet still be able to operate correctly, without being effected by incorrect low power modes. Embodiments of the present invention aim to provide such functionality.

### SUMMARY OF THE INVENTION

Embodiments of the invention provide a power management subsystem which provides an interface which allows baseport subsystems such as device drivers and the like to register operational constraints on system resources such as power supplies, clocks, and the like, as well as to specify a maximum allowable wake-up time to ensure correct operation. Once registered, such operational constraints are then typically sorted to determine the strictest constraints, and the strictest constraints are then mapped to the characteristics of the various low-power modes offered by a particular device platform, to determine the most appropriate low power mode which can be entered whilst still allowing the registered constraints to be met. In this way, when required a device having the power management subsystem can still make use of low power modes when appropriate, without compromising the operation of base port sub systems such as device drivers, controllers, or the like. Additionally, the power management subsystem insulated the base port subsystems from the low power modes provided by the device, such that existing base port subsystem components can be used with the device, without requiring any bespoke tailoring thereto.

In view of the above, from a first aspect the present invention provides an apparatus having a plurality of system resources, said system resources being utilised by other system components of the apparatus, the apparatus further providing one or more low-power modes in which at least one or more of said system resources is/are, at least partially disabled whereby to save power, the apparatus further comprising a power management sub-system arranged to select and implement a low power mode in dependence on system resource operating constraints set by the other system components which make use of said system resources. The provision of the power management subsystem provides the advantages noted above, i.e. the most appropriate low power mode can be selected which does not compromise system component operation, and moreover system components can be used off the shelf without bespoke tailoring to the particular characteristics of the low power modes offered by an particular apparatus.

From a second aspect the invention also provides a power management method for managing a plurality of system resources, said system resources being utilised by other system components, the system resources being subject to one or more low-power modes in which at least one or more of said system resources is/are, at least partially, disabled whereby to save power, the method comprising selecting a low power mode in dependence on system resource operating constraints set by the other system components which make use of said system resources, and implementing said selected low power mode. The same advantages are obtained in the second aspect as described above in the respect of the first aspect.

Further aspects, features, and advantages of the present invention will be apparent from the appended claims, as well as from the following description.

### DESCRIPTION OF THE DRAWINGS

Further features and advantages of the present invention will become apparent from the following description of an embodiment thereof, presented by way of example only, and with reference to the drawings, wherein like reference numerals refer to like parts, and wherein:—

FIG. 1 is a block diagram of a device platform 10 described as background to the embodiment of the invention;

FIG. 2 is a diagram of a clock tree used in the device platform 10;

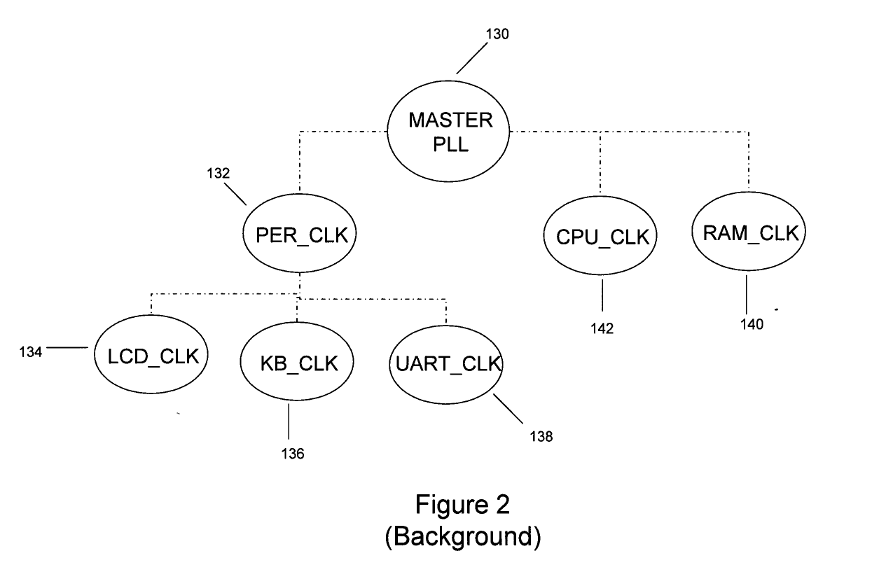

FIG. 3 is a table illustrating properties of power save modes used in the device platform 10;

FIG. 4 is a block diagram of a device according to a first embodiment of the present invention;

FIG. 5 is a block diagram of an element of the power management subsystem provided in the device according to the embodiment of the invention;

FIG. 6 is a flow diagram illustrating the steps performed by an element in the power management subsystem of an embodiment of the invention;

FIG. 7 is a block diagram of another element of the power management subsystem of the embodiment of the invention;

FIG. 8 is a flow diagram illustrating the steps performed by the other element of the power management subsystem of the embodiment of the invention;

FIG. 9 is a block diagram of a further element of the power management subsystem of the embodiment of the invention;

FIG. 10 is a flow diagram illustrating the steps performed by the further element of the power management subsystem within the embodiment of the invention;

FIG. 11 is block diagram of a power mode controller used in a power management subsystem of the embodiment of the invention; and

FIG. 12 is a flow diagram illustrating the steps performed by the power mode controller of FIG. 11.

### DESCRIPTION OF THE PREFERRED EMBODIMENT

Description of an embodiment of the invention, based upon the above description of an example device platform 10 made above by way of background, will be undertaken below. However, before undertaking such a detailed description, a brief overview of the operation of the embodiment of the invention is provided next.

The embodiment of the invention provides a power management subsystem on a device to which an operating system is being ported to, which subsystem allows device drivers and controllers, such as UART controller 412, to register which hardware or other system resources they need to continue to operate in any low power mode which the device may enter. For example, the device drivers or controllers may each individually register constraints with the power management subsystem as to, for example, which clocks are required for their operation, which power supplies are required, and what the maximum wake up time which they can usefully tolerate may be. Each device driver or controller may register constraints in only one particular constraint category i.e. which clocks are required, or may register constraints in several categories. The power management subsystem provides an interface by which the controllers and drivers may register such constraints.

With such constraints registered, for each constraint type e.g. for power domains, or for clocks, a constraint handler unit is provided, which keeps track of the constraints registered by the base port subsystems such as the device drivers and controllers, and compares the requirements set out in the registered constraints with the properties of the various low power modes offered by the device platform. The handler units then select the most aggressive low power mode which satisfies all of the registered constraints. It may be, that for each different constraint type, the respective handler for that constraint type is able to select a different low power mode than the handler for another constraint type, depending upon the exact constraints registered.

An overall power mode controller is then provided in the power management subsystem, which receives instructions from the operating system scheduler to cause the device to enter a low power mode. The power mode controller then polls the individual constraint handlers to determine which low power mode they are presently able to offer based on the constraints registered therewith. Of the power modes which are returned from the various constraint handlers, the least aggressive power mode is then selected by the power mode controller, which then controls the hardware of the device platform, such as, for example, the clocks and power domains, in accordance with the selected power mode. The least aggressive power mode is selected such that all of the constraints registered by the device drivers and controllers can be met.

In this manner it is possible for the device platform still to use low power modes when possible, thus prolonging battery life, for example, but the needs of base port subsystems such as device drivers and controllers which are presently active are still met, and hence the correct operation of the device can be ensured. Moreover, because the power management subsystem operates to match the device driver and controller constraint requirements with the power modes offered by the device, the individual base port subsystems need not have any knowledge of the power modes offered by the device platform. Instead, all they need to know about is the interface to the power management subsystem, in order to allow the base port subsystems to register constraints therewith. This is particularly advantageous, as by removing the need for the base port subsystems to have knowledge of the power management modes offered by a device platform, it becomes much easier to port an operating system onto any device platform, without having to perform bespoke adaptation to the device drivers and controllers of the operating system, or any other base port subsystems, to tailor those components to the particular power modes offered by the particular device platform. Thus, integration of an existing operating system with a new device platform can be more readily performed.

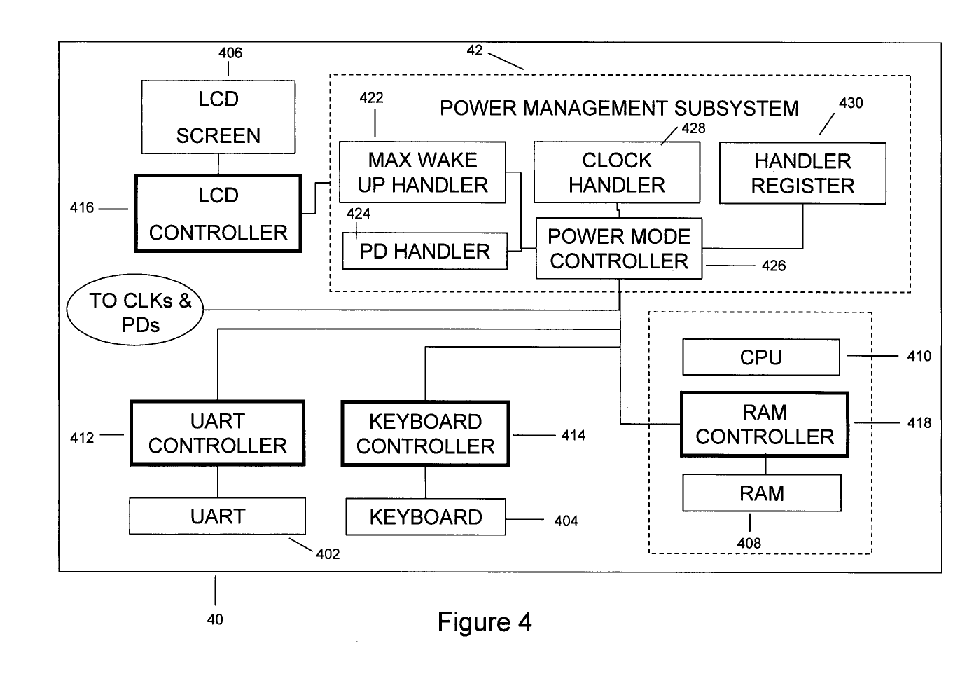

With the above overview in mind, a detailed description of the preferred embodiment, presented by way of example only, will now be made with respect to FIGS. 4 to 12.

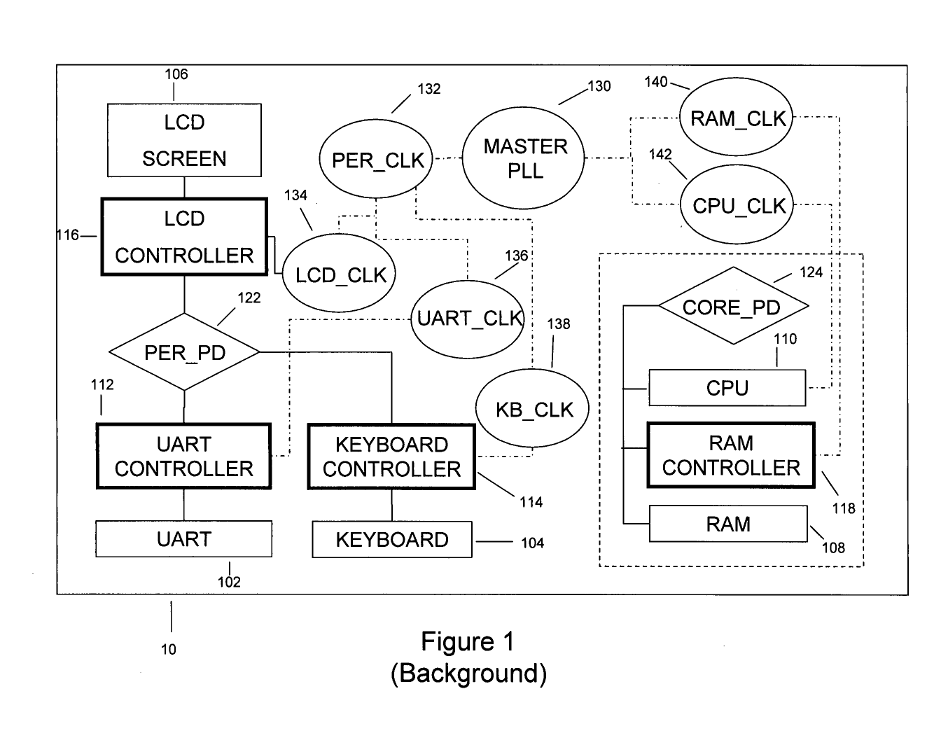

FIG. 4 illustrates a device 40 according to an embodiment of the invention. The device 40 may be, for example, a mobile telephone, a PDA, a media player, a computer, or the like. The device comprises a core having CPU 410, and RAM 408. A RAM controller 418 is provided to control the reading from and writing to of data in the RAM 408. The RAM controller 418 forms part of the hardware abstraction layer of the operating system for the device, not shown. Also provided is an LCD screen 406, and a corresponding LCD controller 416, being the appropriate device driver to allow the operating system of the device 40 to control the LCD screen 406. Similarly, a universal asynchronous receiver/transmitter 402 is provided, with associated UART controller 412, again forming part of the hardware abstraction layer of the operating system. Finally, a keyboard 404 is provided, with associated keyboard controller 414, again being part of the hardware abstraction layer. In addition to the hardware elements described and their associated controllers, various power supplies and clocks are provided to power the hardware elements and their controllers, and to provide clock signals thereto. In the example device 40 according to the present embodiment, the power domains and clocks are the same as described previously with respect to the example platform device 10 of FIG. 1. As such, the power supplies and clocks are not shown in FIG. 4.

Additionally provided within the embodiment to cause the embodiment to operate in accordance with the invention is a power management subsystem 42. The power management subsystem 42 comprises a power mode controller 426, which provides an interface which the base port subsystems such as the device drivers and controllers can communicate with, in order to register constraints, as will be described later. The power mode controller 426 also communicates with handler register 430, which keeps a track of the different types of constraint for which constraint values may be registered against. Additionally provided are the individual constraint handlers, in this case a clock constraint handler 428, which keeps track of registered constraints concerning which clocks base port subsystems require to continue operation in any low power mode. Additionally provided is maximum wake up time handler 422, which keeps a track of registered constraints relating to the allowable maximum wake up time of the device set by the base port components. Similarly, a power domain handler 424 is also provided, which keeps track of registered constraints concerning which power domains are required to continue operation in any low power mode. Each of the handlers communicates separately with the power mode controller 426. Additionally, the power mode controller 426 is controlled by the operating system scheduler of the device (not shown) to receive instructions from the scheduler that a low power mode is to be entered. The power mode controller 426 also communicates with the various clocks and power domains, in order to be able to gate the clocks and domains so as to cause a low power mode to be entered.

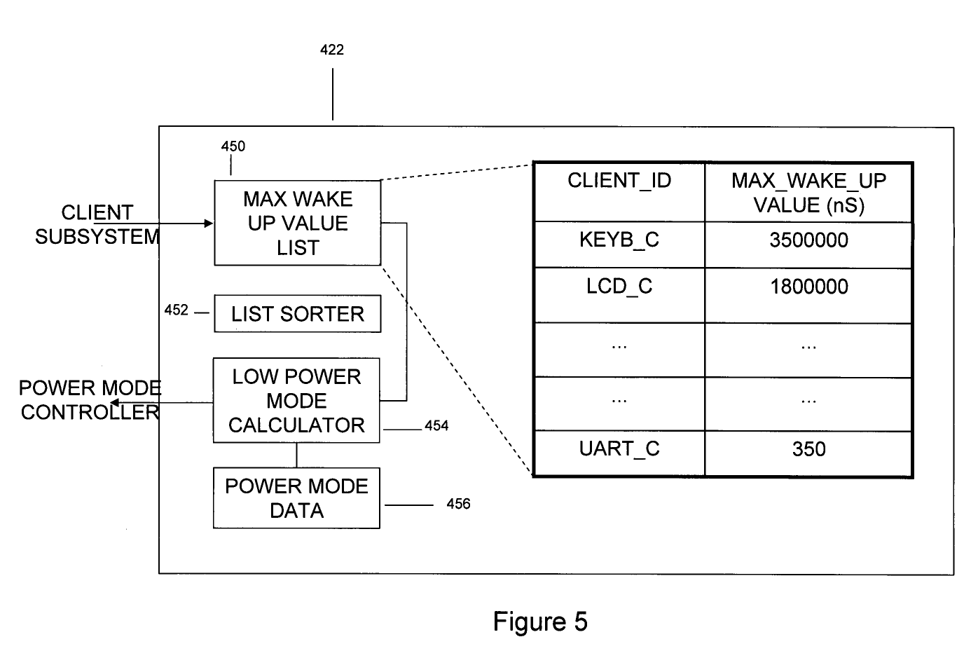

FIG. 5 illustrates in more detail the internal components of the maximum wake up time handler 422. In particular, maximum wake up time handler 422 comprises a maximum wake up value list 450, as shown in FIG. 5. Here, it can be seen that the list comprises a table containing, in a first column, client IDs, being the IDs of the base port subsystems which have registered constraints. The second column in the table represents the actual constraint which has been registered. Thus, for example, in FIG. 5 it can be seen that the UART controller 412, represented by client ID UART-C has registered with the maximum wake up time handler 422 a constraint that its maximum allowable wake up value that it can tolerate is 350 nanoseconds. Similarly, the LCD controller identified by the client ID LCD_C has registered a constraint that its maximum wake up value is 1.8 million nanoseconds. Constraints relating to maximum wake up times are stored in the maximum wake up value list 450 when they are received from client base port subsystems via the interface provided thereto by the power mode controller. When a new constraint value is received, in the form a tuple (client-ID, maximum wake up time value) then where the client ID is not in the list already, the client ID and the wake up value are added to the list. Where the client ID is already in the list, then the new wake up value is stored in place of the previously stored value. Thus, at any time, only one maximum wake up time constraint value is stored against any client ID.

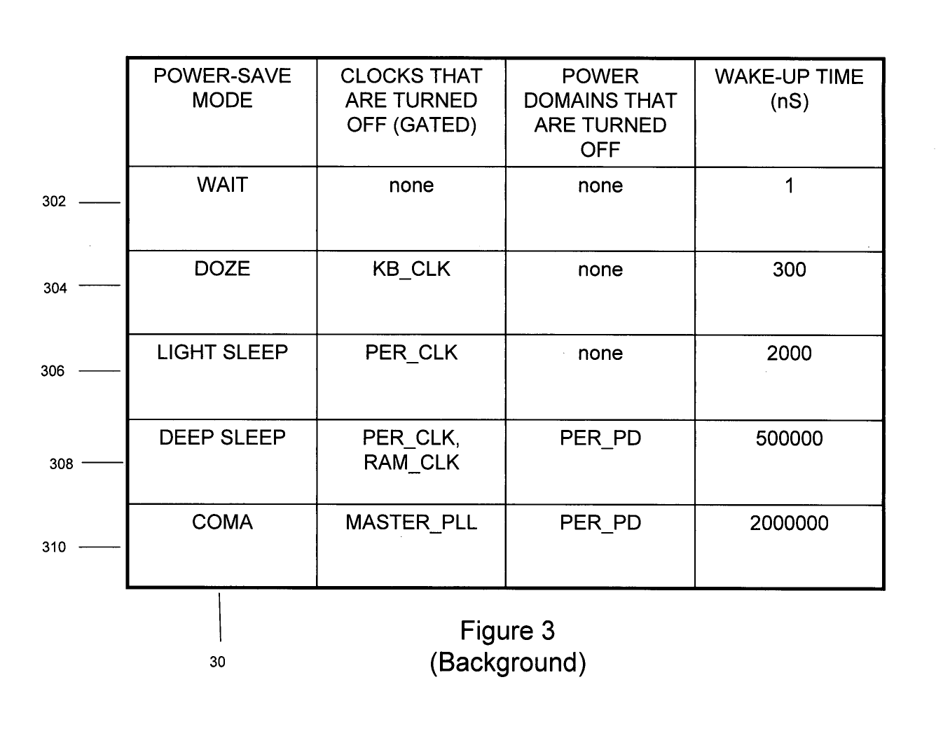

A list sorter 452 is also provided, which acts in operation to sort the maximum wake up value list 450, whenever a change is made thereto. A low power mode calculator 454 receives the sorted list, and is further provided with power mode data 456, which provides the characteristics of the various power modes provided by the device. The power mode data 456 therefore represents the data, for example, set out in FIG. 3, described previously, giving the characteristics of each power save mode provided by the device platform 40. From the power mode data, and the sorted list, the low power mode calculator 454 is able to determine which is the most appropriate low power mode which meets the maximum wake up constraint values which are registered with the handler 422, and is able to provide this information back to the power mode controller.

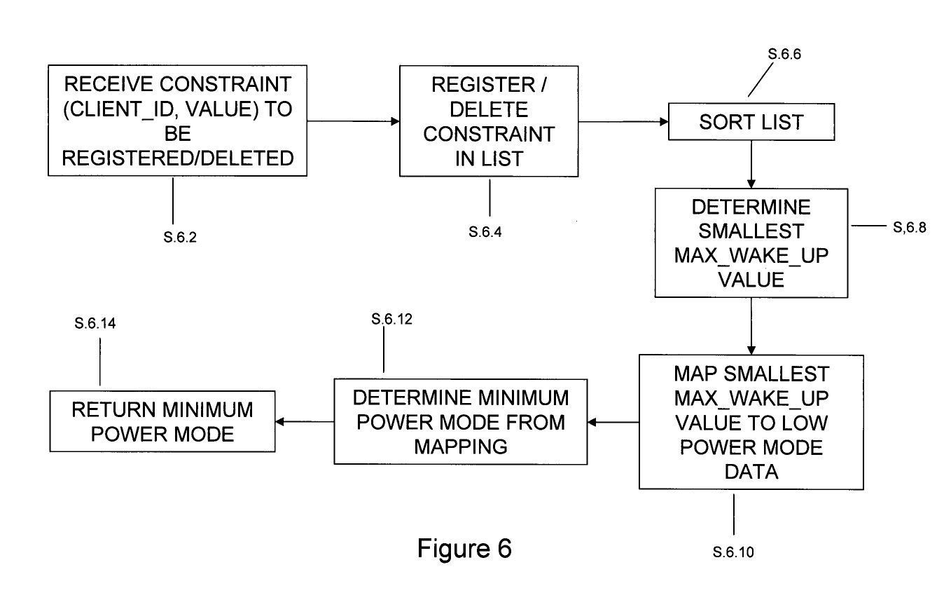

FIG. 6 is a flow diagram illustrating the operation of the various components of the maximum wake up time handler 422.

More particularly, at step 6.2 the maximum wake up time handler 422 receives from the power mode controller 426 instructions that a constraint in the form of the tuple (client_ID, value) is to either be registered in the maximum wake up value list, or deleted therefrom. In this respect, as described previously, the power mode controller 426 provides an interface to the base port subsystems, to allow them to indicate to the power management subsystem when constraints are to be registered or deleted. Typically, a base port subsystem such as a device driver or controller would register constraints when the driver or controller is first activated e.g., for example, first loaded into memory. When the driver or controller is deactivated e.g. unloaded from memory, then it uses the interface to the power management subsystem to indicate that its registered constraints can be deleted.

At step 6.4, having received the registration or deletion instructions from the power mode controller, the maximum wake up time handler then performs the amendment to the maximum wake up value list 450, i.e. where the client ID is not presently contained in the list, the client ID is added to the list, together with the wake up value indicated. Where the client ID is already in the list, then the wake up value in the list is updated with the newly received value. Where a constraint is to be deleted, then the constraint relating the client ID is simply deleted from the list.

Whenever any change happens to the maximum wake up value list 450, it is then necessary that list sorter 452 re-sorts the list to place it into order of the registered maximum wake up values. This is performed by the list sorter 452 at step 6.6.

Thereafter, after every list sorting, the low power mode calculator 454 looks at the list, and at step 6.8, determines the smallest maximum wake up value. In the example list shown in FIG. 5, this would be the maximum wake up value of 350 nanoseconds, registered against the UART controller 412.

Having determined the smallest maximum wake up value, at step 6.10 the low power mode calculator maps the smallest maximum wake up value to the low power mode data 456, in order to determine, at step 6.12, the minimum power mode which meets the constraint of the smallest maximum wake up value. Thus, for example, where the power modes have the properties shown in the table of FIG. 3, in the present example where the smallest maximum wake up value is 350 nanoseconds, it can be seen that the only low power modes which meet this requirement are those of “WAIT” and “DOZE”. In this case the “DOZE” power save mode is the most aggressive power save mode i.e. provides the greatest power saving, and hence this is returned as the minimum power mode, at step 6.14. The low power mode calculator 454 returns the determined minimum power mode to the power mode controller, typically when polled therefor.

Thus, the maximum wake up handler 422 provides a mechanism by which constraints relating to maximum wake up time can be registered with the power management subsystem, and then compared with the power mode data, in order to determine the most aggressive low power mode which meets the maximum wake up time constraints.

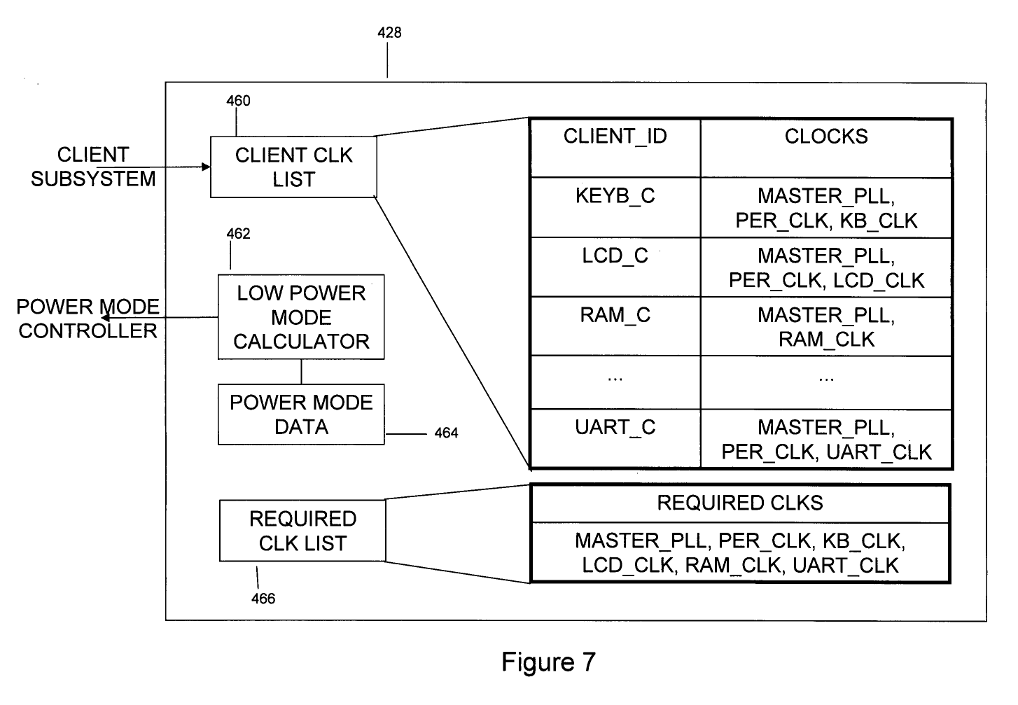

Turning to FIG. 7, FIG. 7 illustrates the internal components of the clock handler 428. The clock handler 428 provides similar functionality to the maximum wake up time handler 422 previously described, but in this case registers constraints relating to which clocks base port subsystems require. To this end, the clock handler 428 comprises a client clock list 460 in which a list of clocks which a client base port subsystem requires are contained, indexed by client ID. A base port subsystem such as a device driver or controller uses the interface provided by the power mode controller to register a constraint relating to its required clocks. Passing to the power mode controller a tuple in the form (client_ID, CLK list), where “CLK list” is a list of the clocks that the driver or controller requires. The power mode controller 426 passes the received constraint data to the clock handler 428, which registers the constraint in the client clock list 460.

Whenever the client clock list 460 is updated, either by registering a new constraint, amending an existing constraint, or deleting an existing constraint, then a second list, being the “required clock list” 466 is also updated. The required clock list is derived from the client clock list 460, and is a simple list of all of the individual clocks which are registered in the client clock list 460, presented once only in the required clock list. Therefore, for example, both the keyboard controller and the LCD controller require the master_PLL, and the PER_CLK clock signals to operate, but these clock identifiers are only included in the required clock list 466 once.

A low power mode calculator 462 is also provided in clock handler 428, together with power mode data 464, again which represents the characteristics of the various power modes provided by the device platform 40. The low power mode calculator 462 then compares the clocks set out in the required clock list 466 with the power mode data 464, to determine the most aggressive low power mode which satisfies the registered clock constraints. The determined low power mode is then passed back to the power mode controller 426.

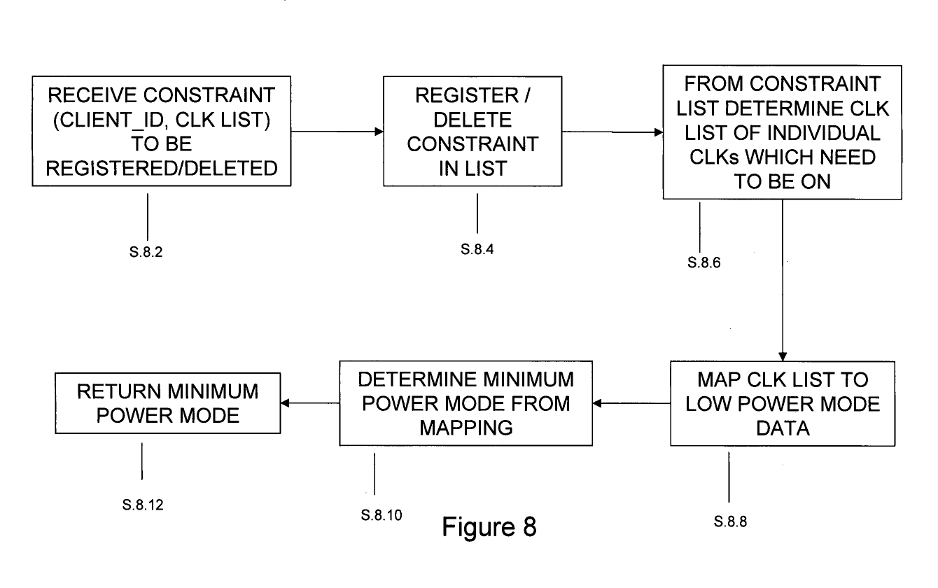

FIG. 8 illustrates in more detail the operation of the clock handler 428. Here, when the clock handler 428 receives constraint data in the form of the tuple (client_ID, clock list) at step 8.2, at step 8.4 it then registers or deletes the received constraint from the client clock list 460. As described previously with respect to the maximum wake up time handler 422, base port subsystems such as device drivers and controllers will typically register clock constraints when they are first activated, and then request the constraints to be deleted when they are deactivated. In this way, the effect of the constraints is minimised, and the most appropriate low power mode can be obtained at all times.

When the client clock list 460 has been altered at step 8.6 the required clock list 466 is updated to contain the IDs of the individual clocks which the constraint list indicates are required to be on. At step 8.8 the low power mode calculator 462 then maps the required clock list 466 to the low power mode data 464, to determine, at step 8.10, the minimum power mode. Thus, for example, in the example of FIG. 7, where all of the clocks are required then, from FIG. 3, it can be seen that the only low power mode which satisfies this requirement that all of the clocks are active is the “WAIT” mode. At step 8.12 the minimum power mode which has been determined is returned to the power mode controller 426.

The clock handler 428 therefore provides a mechanism by which constraints regarding which clocks are required by base port subsystems can be registered, and used to determine which of the available low power modes provided by the device 40 can be used.

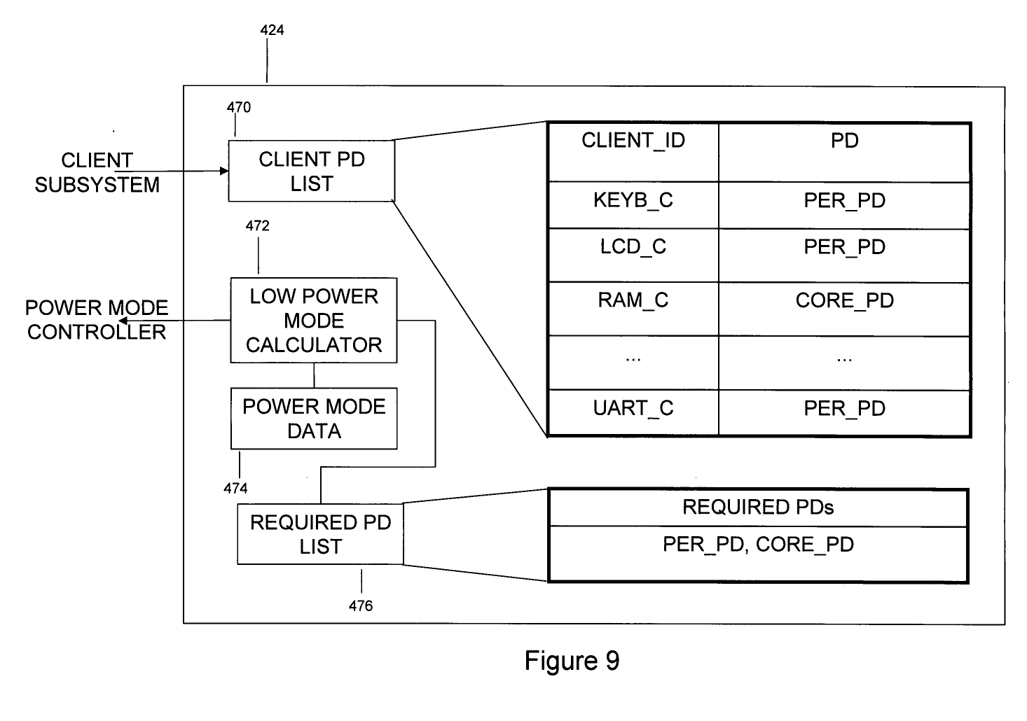

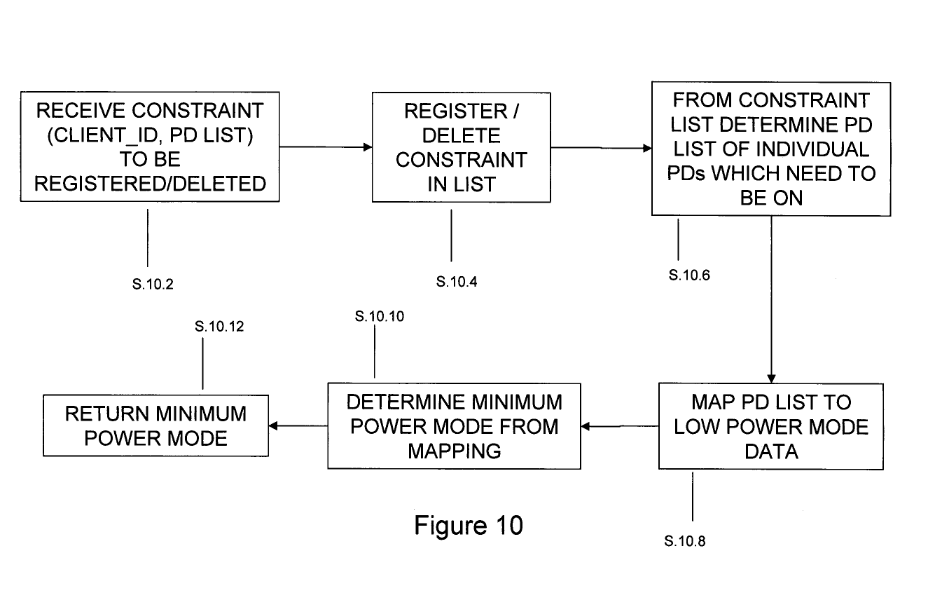

FIGS. 9 and 10 illustrate the operation of the power domain handler 424. In this respect, the operation of the power domain handler 424 is very similar to that of the clock handler 428. A client power domain list 470 is stored therein, containing individual constraints registered by device base port subsystems, indexed by client ID. Thus, for example, it can be seen that the RAM controller has registered that the core power domain must remain active, whereas the LCD controller has registered that the PER_PD must remain active.

From the client PD list 470 a required PD list 476 is derived, containing only those unique power domain IDs. In this case, both power domains PER_PD, and CORE_PD are included. A low power mode calculator 472 uses the required PD list 476 and compares it against stored power mode data 474 to determine the minimum power mode therefrom. The determined minimum power mode is then returned to the power mode controller 426. Details of this operation are shown in FIG. 10. However, it will be seen that the operation is almost identical to that of FIG. 8 described previously, and hence description of the operation will not be repeated.

The power domain handler 44 therefore also provides a mechanism by which constraints can be registered by base port subsystems in respect of which power domains must be kept operational, and then these constraints can be mapped to the individual low power modes provided by the device 40 to determine the most appropriate mode which may be used. In the example shown in FIG. 9, wherein both the PER_PD and CORE_PD power domains are required, then with reference to FIG. 3 it can be seen that the most aggressive low power mode which supports this requirement is the “LIGHT SLEEP” mode, as that is the most aggressive power saving mode in which neither of the power domains are turned off.

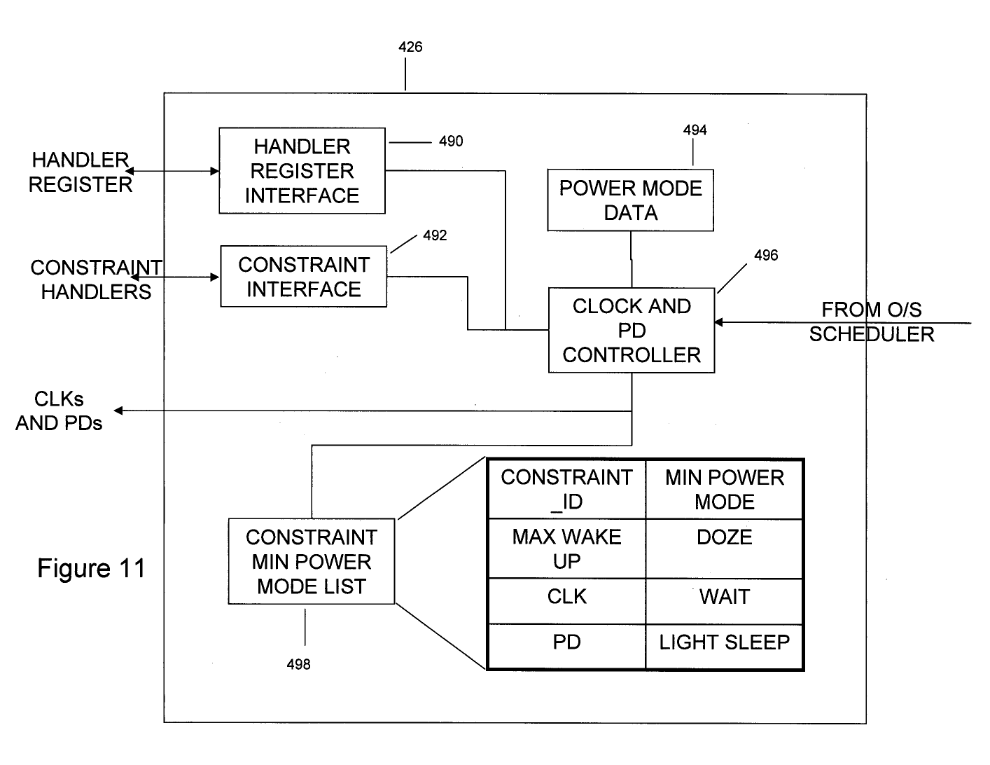

Thus, as described above, the individual constraint handlers each return to the power mode controller information indicating which of the low power modes offered by the device platform 40 satisfies the constraints registered with each handler by the base port subsystems. The power mode controller 426 then stores the minimum power mode information returned by each handler in a minimum power mode list 498, and from this list determines which power mode can be used at any particular time should the operation system scheduler request the device enter a low power mode. In this respect, in order to meet all of the different registered constraints of different types, of the different minimum power modes returned by the different constraint handlers, the least aggressive mode must be chosen. By “least aggressive” it is meant the power mode which saves the least power. In the example shown in FIG. 11, wherein the minimum power mode list 498 indicates the minimum power modes “DOZE”, “WAIT” and “LIGHT SLEEP” then the mode “WAIT” would be selected, as the least aggressive mode. Only this mode satisfies all of the different constraints registered with all of the constraint handlers, in the present example.

Looking at FIG. 11, the power mode controller 426 comprises a clock and power domain controller 496, power mode characteristic data 494, and a constraint interface 492. The constraint interface 492 allows the power mode controller 426 to communicate with the constraint handlers. Additionally provided is a handler register interface 490, which allows the controller 426 to interface with the handler register 430. The clock and power domain controller 496 also sends control signals to the clocks and power domains, and in particular enable or disable signals in order to gate the clocks and power domains when required. Additionally, the controller 496 receives instructions from the OS scheduler to enter a low power mode, and acts accordingly thereon.

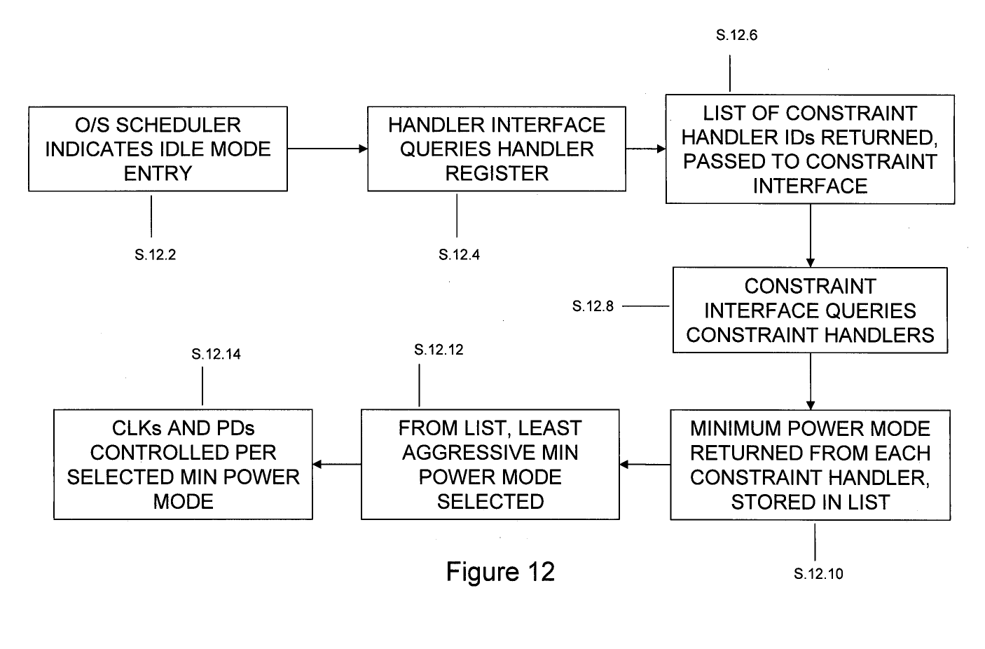

The operation of the power mode handler 426 is shown in FIG. 12. Here, the power management subsystem 42 operates to cause the device 40 to enter a low power mode when a signal is received from the device operating system scheduler (not shown) that a low power mode is desirable, for example because there are no further processes or threads to be processed. The power mode controller 426 receives such a signal internally at the clock and power domain controller 496, at step 12.2. In response to such a signal being received from the OS scheduler, the clock and power domain controller 496 controls the handler register interface 490 to query the handler register 430, at step 12.4. The handler register 430 then returns a list of constraint handler IDs, at step 12.6, and the clock and power domain controller 496 passes these constraint handler IDs to the constraint interface 492.

At step 12.8 the constraint interface 492 queries the constraint handlers so as to obtain from each handler an indication of the minimum power modes which the constraints registered with each constraint handler will allow. Thus, for example, the constraint interface 492 queries each of the maximum wake up time handler 422, the power domain handler 424 and the clock handler 428, such that each of the handlers returns to the power mode controller 426 the minimum power mode which it presently has calculated, based upon the constraints presently registered therewith. The minimum power mode information returned from each constraint handler is stored in the minimum power mode list 498, at step 12.10. Next, at step 12.12 the clock and power domain controller 496 looks at the minimum power mode list 498, and selects from the list of available minimum power modes the least aggressive minimum power mode. As mentioned previously, by selecting the least aggressive power mode, then all of the constraints of the different types can be guaranteed to be met. Having selected the appropriate low power mode to implement, the clock and power domain controller 496 then acts to implement the selected minimum power mode, by controlling the clocks and power domains, at step 12.14. In particular, the clock and power domain controller 496 sends disable signals to the particular clocks and power domains which are to be gated in accordance with the profile of the selected power mode.

Thus, as described above, the embodiment of the invention allows for the most appropriate low power mode to be selected in order for power to be saved, an important requirement for battery operated devices such as mobile telephones, but means that the correct operation of the various base port subsystems can be guaranteed, by allowing those base port subsystems to register, via the interface provided by the power management subsystem, constraints relating to the hardware resources which any base port subsystem requires to operate correctly. Moreover, the provision of the power management subsystem effectively insulates the base port subsystems from the different power modes supported by any particular device platform 40, in that each base port subsystem, being a driver or controller, for example, does not need to know anything about the individual low power modes provided by the device platform. Instead, each base port subsystem need only have functionality to allow it to use the power management subsystem interface to register constraints. Therefore, when an operating system is being ported to a new device platform, provided the device platform is provided with a power management subsystem, then existing base port subsystem components such as device drivers and controllers can be used on the new device platform, without requiring adapting to take into account the low power modes offered by that device platform. This provides significant cost savings and allows new device platforms to be integrated with existing operating systems to provide a complete product more swiftly than has heretofore been the case.

Additionally, the mechanism provided by the power management subsystem to determine the most low power mode to enter depending upon the registered constraints is advantageous because it is essentially a non-iterative process. The individual constraint handlers constantly update their minimum power mode depending on the constraints as presently registered with them. This means that when the power management subsystem is instructed by the operating system scheduler to enter a low power mode, then the power mode controller 426 can immediately obtain from the constraint handlers the most appropriate low power mode which meets their respective constraints, and can then determine therefrom very straightforwardly which is the minimum power mode which should be selected overall. Thus, there is very little delay between the scheduler requesting a low power mode be entered, and the selection and entering of the appropriate low power mode.

Moreover, the power management subsystem is adaptive, in that by virtue of the operation of the handlers in maintaining lists of the constraints presently registered therewith, and updating their minimum power modes returned therefrom in dependence on changes in the list, whenever a base port subsystem is deactivated, such as, for example, by being unloaded from memory, then any constraints registered with the constraint handlers for that base port subsystem are preferably deleted (or otherwise ignored) from the lists of constraints held thereby, and the minimum power mode updated accordingly. An example will make this aspect clearer.

In the example operation described previously with respect to the figures, due to the constraints registered in the lists shown in the figures, then the minimum power mode selected upon activation of a low power mode was the “WAIT” mode. This was because the clock handler 428 had indicated that this was the minimum power mode that its constraints could support (see FIG. 11). The reason for this is that the keyboard controller had registered a constraint with the clock handler, requiring the KB_CLK clock to be active. However, in the event that the keyboard controller 414 is deactivated such as, for example, by being unloaded from memory in the event that the keyboard is not being used, then the constraint registered by the keyboard controller in the client clock list 460 will be deleted therefrom. This will cause the required clock list 466 to be updated, to delete the KB_CLK clock signal from the required clock list. In turn, and with reference to FIG. 3 indicating the low power mode properties, it will be seen that where the KB_CLK clock is no longer required, then the most aggressive low power mode which still meets the list of required clocks becomes the “DOZE” mode. Thus, the clock handler 428 would return the “DOZE” power mode as its minimum power mode to the power mode controller, when queried. Assuming that the maximum wake up time handler 422 and power domain handler 424 return the same minimum power modes as previously, the change in the returned minimum power mode from the clock handler 428 would allow the power mode controller 426 to select the “DOZE” power save mode, should the operating system scheduler request a low power mode to be entered. Thus, by having the constraint handlers update the minimum power modes in dependence upon the constraints registered therewith, and in particular by having constraints deleted or otherwise ignored when a base port subsystems which registered the constraint is no longer active, then the most appropriate low power mode can be repeatedly and adaptively selected.

Various changes and modifications may be made to the above described embodiment to provide further embodiments of the invention. For example, whilst in the embodiment we have described the base port subsystem in terms of an LCD controller, UART controller, keyboard controller and RAM controller, it will be readily apparent to the intended reader that various other base port subsystems can be used. The main requirement is that each base port subsystem, being, for example, device drivers or controllers, is adapted to allow it to register constraints when it is activated via the interface provided by the power management subsystem.

Additionally, we have described in the embodiment above three types of constraints, being maximum wake up time, available clocks, and available power supplies. Other types of constraint are also possible. For example constraints on different types of memory which are available may be made. Further types of constraint will be apparent to the intended reader.

Additionally, in the example given above we have set out in FIG. 3 particular properties for different power modes. Of course, in other embodiments of the invention, a different number of low power modes may be provided, having different characteristics. Indeed, one of the main advantages provided by embodiments of the invention is that they allow the same base port subsystems i.e. device drivers, controllers and the like forming the operating system hardware abstraction layer to be used with different device platforms which offer many different types of low power modes, each with different characteristics. The power management subsystem provided by embodiments of the invention effectively insulates the operating system hardware abstraction layer from the low power modes offered by any particular hardware platform.

Various further modifications will be apparent to the intended reader, being a person skilled in the art, to provide further embodiments of the present invention, any and all of which are intended to be encompassed by the appended claims.

1-26. (canceled)

27. An apparatus comprising a plurality of system resources, said system resources being utilised by baseport sub-system components of the apparatus, the apparatus further providing a plurality of low-power modes in which the plurality of system resources are at least partially disabled, the apparatus further comprising a power management sub-system arranged to select and implement a low power mode in dependence on system resource operating constraints set by the baseport sub-system components which make use of said system resources.

28. An apparatus according to claim 27, wherein the power management sub-system comprises: at least one system resource constraint handler; and a power mode controller; wherein the system resource constraint handler comprises a store for storing system resource operating constraints, and a power mode calculator which determines a low power mode in dependence on the stored system resource operating constraints; wherein the power mode controller controls the systems resources to be, at least partially, disabled in dependence on the determined low power mode.

29. An apparatus according to claim 28, wherein the power management sub-system further comprises a plurality of system resource constraint handlers for a plurality of system resource constraints, each handler determining a relevant low power mode for its own constraints; wherein the power mode controller receives the plurality of determined low power modes, and selects a low power mode to meet substantially all system resource constraints.

30. An apparatus according to claim 28, wherein the or each constraint handler further comprises a second store storing low power mode characteristic information, and wherein the power mode calculator maps the stored system resource operating constraints to the low power mode characteristic information to determine the most appropriate low power mode to meet the stored system resource operating constraints.

31. An apparatus according to claim 28, wherein the system resource operating constraints are stored as a list of numerical values sorted to determine the maximum or minimum values, and wherein the power mode calculator selects the low power mode whose characteristics at least meet the maximum or minimum value.

32. An apparatus according to claim 27, wherein the system resource operating constraints include a maximum apparatus wake-up time.

33. An apparatus according to claim 28, wherein the system resource operating constraints are stored as a list of system resource IDs, wherein the power mode calculator selects the low power mode whose characteristics are such that the system resources whose IDs are stored are maintained in operation during the low power mode.

34. An apparatus according to claim 27, wherein the system resource operating constraints include a list of clocks that must be maintained in operation.

35. An apparatus according to claim 27, wherein the system resource operating constraints include a list of power supplies that must be maintained in operation.

36. An apparatus according to claim 27, wherein the system resource operating constraints for the baseport sub-system components are set on activation of the components.

37. An apparatus according to claim 27, wherein when a baseport sub-system component is deactivated, any system resource operating constraints it has set are no longer applied.

38. A power management method for managing a plurality of system resources, said system resources being utilised by baseport sub-system components, the system resources being subject to a plurality of low-power modes in which the plurality of system resources are at least partially disabled, the method comprising selecting a low power mode in dependence on system resource operating constraints set by the baseport sub-system components which make use of said system resources, and implementing said selected low power mode.

39. A method according to claim 38, further comprising storing system resource operating constraints; determining a low power mode in dependence on the stored system resource operating constraints; and disabling, at least partially, one or more systems resources in dependence on the determined low power mode.

40. A method according to claim 39, further comprising storing low power mode characteristic information, and mapping the stored system resource operating constraints to the low power mode characteristic information to determine the most appropriate low power mode to meet the stored system resource operating constraints.

41. A method according to claim 38, wherein the system resource operating constraints include a maximum apparatus wake-up time.

42. A method according to claim 38, wherein the system resource operating constraints include a list of clocks that must be maintained in operation.

43. A method according to claim 38, wherein the system resource operating constraints include a list of power supplies that must be maintained in operation.

44. A method according to claim 38, wherein the system resource operating constraints for the baseport sub-system components are set on activation of the components.

45. A computer program or suite of computer programs so arranged such that when executed by a computer system they cause the computer system to operate in accordance with the method of claim 38.

46. A computer readable medium storing a computer program or at least one program of a suite of computer programs according to claim 45.
